(19) United States
(12) Patent Application Publication
(10) Pub. No.: US 2012/0077484 A1
(43) Pub. Date: Mar. 29, 2012

(54) DEVICE AND METHOD FOR TRANSMITTING RANDOM ACCESS CONTROL CHANNEL (RACH) PREAMBLE

(75) Inventor: Su Bok JI, Seoul (KR)

(73) Assignee: PANTECH CO., LTD., Seoul (KR)

(21) Appl. No.: 13/184,753

(22) Filed: Jul. 18, 2011

(30) Foreign Application Priority Data
Sep. 29, 2010 (KR) 10-2010-0094090

(51) Int. Cl. H04W 48/00

(52) U.S. Cl. 455/422.1

(57) ABSTRACT

In a method for transmitting a radio access control channel (RACH) preamble, steps may include supplying power to a device, checking a base time offset for the device, generating a random time offset used to transmit the RACH preamble, and transmitting the RACH preamble based on the checked base time offset or the generated random time offset. Devices having the same base time offset may be grouped together, and devices in a same group may transmit the RACH preamble according to their respective generated random time offsets. A device to transmit an RACH preamble includes a power supply unit, a control unit, an offset generating unit, and a communication unit.

### CROSS-REFERENCE TO RELATED APPLICATION

This application claims priority from and the benefit of Korean Patent Application No. 10-2010-0094090, filed on Sep. 29, 2010, which is hereby incorporated by reference for all purposes as if fully set forth herein.

### BACKGROUND

1. Field

Exemplary embodiments of the present invention relate to a device and a method for transmitting a random access control channel (RACH) preamble, and more particularly, to a device and a method for controlling transmission of a RACH preamble, which may reduce RACH congestion occurring on initial RACH preamble transmission.

2. Discussion of the Background

A machine to machine (M2M) environment provides a service related to wireless communication between systems. When devices in an M2M environment are reset, for example due to an abnormal condition such as electric power supply cut-off, the devices may transmit preambles for re-access to a network. However, if the devices simultaneously transmit preambles for re-access to a network, network congestion may occur. To reduce the network congestion, channel resources may be increased, but this may induce consumption of physical uplink shared channel (PUSCH) resources and inversely affect a traffic data throughput.

### SUMMARY

Exemplary embodiments of the present invention provide a device to control transmission of an RACH preamble and a method for controlling transmission of an RACH preamble by transmitting the RACH preamble using an offset time when devices in a M2M environment.

Additional features of the invention will be set forth in the description which follows, and in part will be apparent from the description, or may be learned by practice of the invention.

An exemplary embodiment of the present invention discloses a method for transmitting an RACH preamble, including supplying power to a device, checking a base time offset for the device, generating a random time offset used to transmit the RACH preamble, and transmitting the RACH preamble based on at least one of the checked base time offset and the generated random time offset.

An exemplary embodiment of the present invention discloses a method for transmitting an RACH preamble, including supplying power to a device, checking a priority and a base time offset for the device, grouping the device into a first group with other devices having a same priority as the priority for the device, the other devices from among a plurality of external devices, generating a random time offset used to transmit the RACH preamble, and transmitting the RACH preamble based on the random time offset.

An exemplary embodiment of the present invention discloses a device to transmit a RACH preamble, including a power supply unit, a control unit to check a base time offset for the device, an offset generating unit to generate a random time offset used to transmit the RACH preamble, and a communication unit to transmit the RACH preamble based on at least one of the checked base time offset and the generated random time offset.

An exemplary embodiment of the present invention discloses a device to transmit a RACH preamble, including a power supply unit, a control unit to check a priority for the device, and to group the device into a first group with other devices having a same priority as the checked priority, the other devices from among a plurality of external devices, an offset generating unit to generate a random time offset used to transmit the RACH preamble, and a communication unit to transmit the RACH preamble based on the generated random time offset.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view illustrating a device to transmit an RACH preamble according to an exemplary embodiment of the present invention.

FIG. 2 is a view illustrating grouping of devices according to an exemplary embodiment of the present invention.

FIG. 3 is a view illustrating setting of a random time offset according to an exemplary embodiment of the present invention.

FIG. 4 is a view illustrating grouping of devices and setting of a random time offset according to an exemplary embodiment of the present invention.

FIG. 5 is a view illustrating a sequent transmission of RACH preambles from a plurality of devices according to an exemplary embodiment of the present invention.

FIG. 6 is a view illustrating an example of overlapping of transmission time of RACH preambles from a plurality of devices.

FIG. 7 is a flowchart illustrating a method for transmitting a RACH preamble in a device according to an exemplary embodiment of the present invention.

FIG. 8 is a flowchart illustrating a method for transmitting a RACH preamble in a device according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

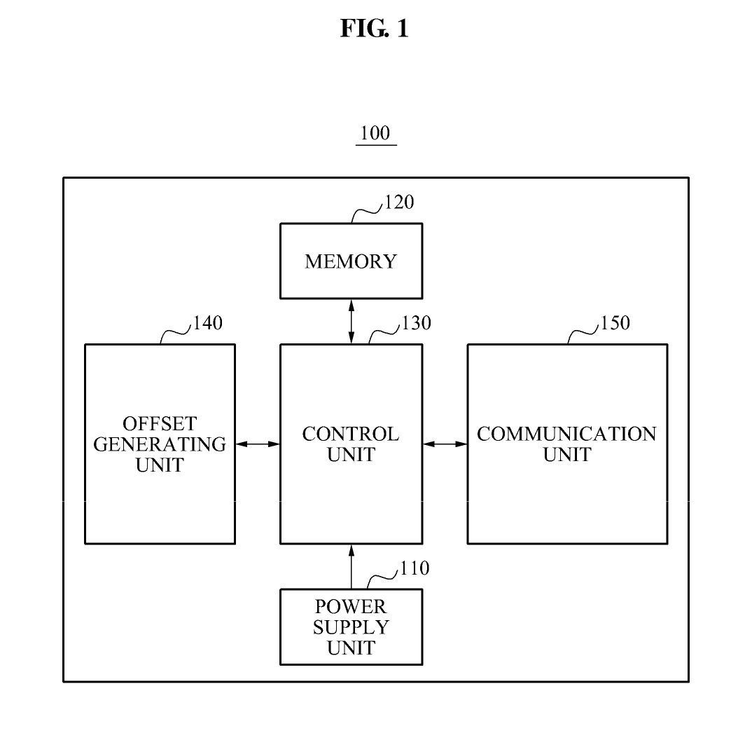

FIG. 1 is a view illustrating a device to transmit an RACH preamble according to an exemplary embodiment of the present invention.

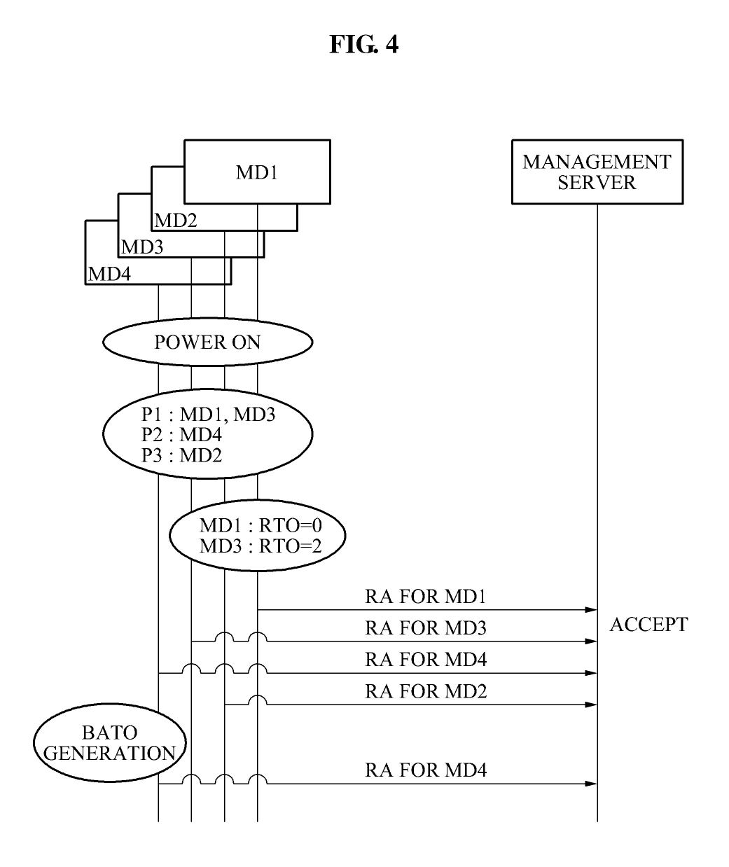

Referring to FIG. 1, the device 100 may operate in an M2M environment. The M2M environment may provide a wired or wireless communication service between two or more devices. If the devices are abnormally terminated in an M2M environment due to, for example, electric power supply cutoff, the devices may be reset at the same time and may simultaneously transmit a radio access resource request signal to a management server (shown in FIG. 4) for initial access to a network. Devices in an M2M environment may set a base time offset based on importance of the devices, and may transmit a radio access resource request signal based on the set base time offset. The radio access resource request signal may be, for example, an RACH preamble. RACH may be an uplink channel used to transmit an access request to a network. Hereinafter, description is made using a RACH preamble as an example of a radio access resource request signal.

Referring to FIG. 1, the device 100 may include a power supply unit 110, a memory 120, a control unit 130, an offset generating unit 140, and a communication unit 150.

The power supply unit 110 may supply power to the device 100.

The memory 120 may store a program used to operate the device 100, and may also store various types of software, various information including setting information, and the like. In particular, the memory 120 may store at least one of priority and a base time offset of the device 100. The priority and the base time offset may be set during manufacturing of the device 100 and may be recorded in the memory 120. Alternatively, when an M2M environment is abnormally terminated and then power is supplied, priority and a base time offset may be allocated by a device, such as a master device, and may be recorded in the memory 120 of the device. The master device may be a mathematical theory of communication (MTC) device having a function for enabling management of some groups among the devices in the M2M environment.

The priority may be selectively allocated based on importance of the device 100. The importance may be importance of a device type. The device type may include, for example, a smart grid, a smart meter, a guard monitor, a smoke detector, an earthquake sensor, and the like. Accordingly, certain devices among a plurality of devices may have the same priority. The base time offset may be a waiting time of the device 100 taken from resetting to initial retransmission of the RACH preamble. The base time offset may have a variable value depending on priority. That is, priority may be allocated based on importance of a device type, and a base time offset may be allocated based on priority. A reference point, that is, an initial setting or starting point used to apply each offset, of each of a base time offset and a random time offset described below may be initially equal for all devices. The reference point may include, for example, a point of time of power resupply, a point of time of checking a base time offset in a memory, and the like.

Table 1 shows an example of priority and a base time offset allocated based on a device type.

TABLE 1

| Device type | Priority | Base time offset (units = seconds) |
|---|---|---|
| Earthquake sensor | 1 | 0 |
| Smoke detector | 2 | 3 |
| Smart meter | 3 | 5 |

In this instance, if the devices include two earthquake sensors, a priority and a base time offset of each respective sensor may be equal.

When power is supplied to the device 100 by the power supply unit 110, the control unit 130 may boot the device 100, and may control the operation of the device 100 or enable the device 100 to perform a function. If the device 100 is reset due to an abnormal condition, the control unit 130 may check a base time offset set on the device 100. For example, the control unit 130 may read priority and a base time offset recorded in the memory 120.

Also, the control unit 130 may attempt to logically group with devices having the same priority or the same base time offset among other devices in the same M2M environment. Accordingly, devices in the M2M environment may be grouped based on a device type, thereby reducing the risk of RACH congestion between groups.

The offset generating unit 140 may generate a random time offset used to transmit a RACH preamble, at random, based on a base time offset recorded in the memory 120. The random time offset may be generated to prevent or reduce RACH congestion between devices in the same group as the device 100. The offset generating unit 140 may generate a random time offset on the same condition with devices having the same base time offset, that is, devices in the same group as the device 100. The condition may be that a random time offset is greater than or equal to a base time offset.

The communication unit 150 may transmit an RACH preamble to a management server (shown in FIG. 4) based on a base time offset checked by the control unit 130 and a random time offset generated by the offset generating unit 140. The communication unit 150 may enable wired or wireless communication in a M2M environment, and may be configured as at least one communication module.

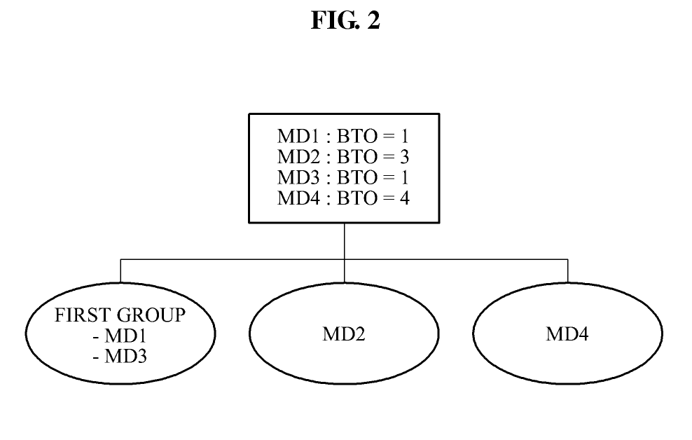

FIG. 2 is a view illustrating grouping of devices according to an exemplary embodiment of the present invention.

Referring to FIG. 2, devices in a M2M environment include a first device MD1, a second device MD2, a third device MD3, and a fourth device MD4, and a base time offset of each device is 1 second, 3 seconds, 1 second, and 4 seconds, respectively. Here, ‘BTO’ corresponds to ‘base time offset.’ ‘BTO=3’ denotes that the RACH preamble is to be transmitted no sooner than 3 seconds after a reference point, such as described above. Because the same base time offset is set on the first device MD1 and the third device MD3, it is understood that the first device MD1 and the third device MD3 have the same device type, the same priority, or the same importance. Accordingly, the first device MD1 and the third device MD3 may be grouped into one logic group.

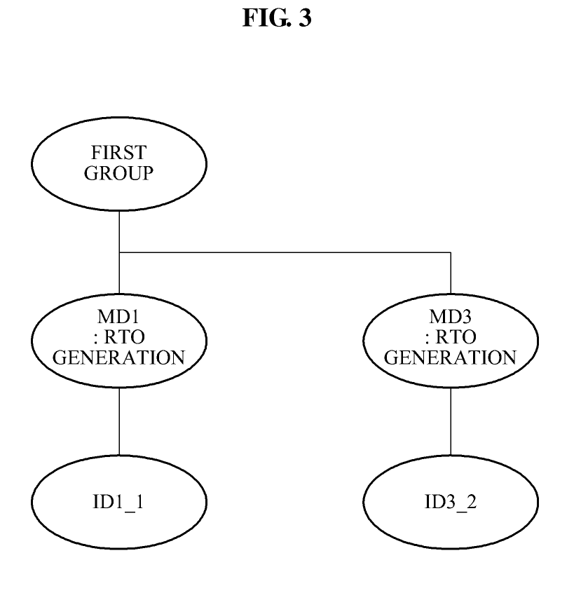

FIG. 3 is a view illustrating setting of a random time offset according to an exemplary embodiment of the present invention.

Referring to FIG. 2 and FIG. 3, the first device MD1 and the third device MD3 having the same base time offset are included in a first group. Accordingly, if the first device MD1 and the third device MD3 transmit an RACH preamble based on a base time offset, RACH congestion may occur. To reduce the risk of the RACH congestion within the same logic group, the first device MD1 and the third device MD3 may generate a random time offset RTO at random using a predetermined scheme or a predetermine program. A random time offset generated by the first device MD1 may be different from a random time offset generated by the third device MD3. In FIG. 3, ‘ID1’ in ‘ID1_1’ indicates ID of the first device MD1, and ‘1’ in ‘ID1_1’ means that a random time offset of the first device MD1 is 1 second. ‘ID3’ in ‘ID3_2’ indicates ID of the third device MD3, and ‘2’ in ‘ID3_2’ means that a random time offset of the third device MD3 is 2 seconds. Accordingly, the first device MD1 may transmit a RACH preamble after 1 second passes from generation of a random time offset. The third device MD3 may transmit a RACH preamble after 2 seconds pass from generation of a random time offset.

FIG. 4 is a view illustrating grouping of devices and setting of a random time offset according to an exemplary embodiment of the present invention.

Referring to FIG. 4, devices in a M2M environment include first device MD1, a second device MD2, a third device MD3, and a fourth device MD4. When a M2M environment is abnormally terminated, power may be supplied to the first device MD1, the second device MD2, the third device MD3, and the fourth device MD4 almost simultaneously. At the same time with power supply, the first device MD1, the second device MD2, the third device MD3, and the fourth device MD4 may check priority set on each of the first device MD1, the second device MD2, the third device MD3, and the fourth device MD4, respectively, and devices having the same priority may be grouped. In FIG. 4, the first device MD1 and the third device MD3 have the same priority, a first priority P1, the second device MD2 has a third priority P3, and the fourth device MD4 has a second priority P2

The first device MD1 and the third device MD3 having the first priority P1 may generate a random time offset RTO based on a base time offset set on the first device MD1 and the third device MD3. In FIG. 4, the first device MD1 generates ‘RTO=0’, and the third device MD3 generates ‘RTO=2’. Because the second device MD2 and the fourth device MD4 are not grouped with other devices, the second device MD2 and the fourth device MD4 may not generate a random time offset.

Accordingly, the first device MD1 that generated a smallest random time offset may try a random access (RA) by transmitting an RACH preamble, and subsequently, the third device MD3, the fourth device MD4, and the second device MD2 may transmit RACH preambles in order.

If transmission of an RACH preamble from the fourth device MD4 fails, the fourth device MD4 may generate a back time offset BATO at random, and if the generated back time offset BATO lapses, the fourth device MD4 may retransmit the RACH preamble.

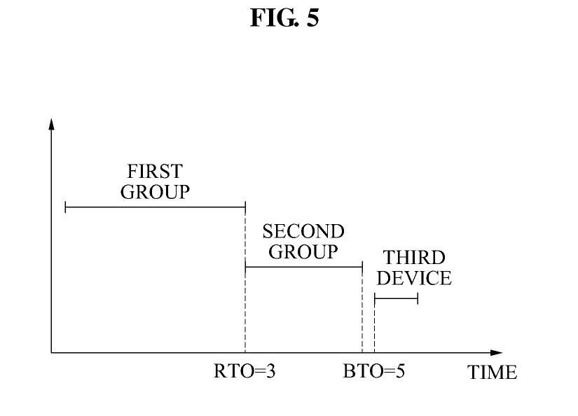

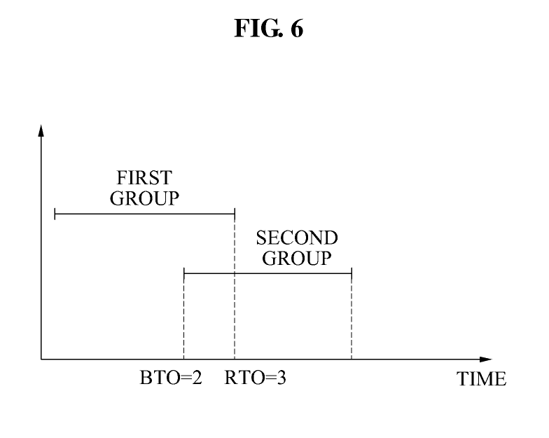

FIG. 5 is a view illustrating a sequent transmission of RACH preambles from a plurality of devices according to an exemplary embodiment of the present invention. FIG. 6 is a view illustrating an example of overlapping of transmission time of RACH preambles from a plurality of devices.

Referring to FIG. 5, a plurality of devices may sequentially transmit RACH preambles based on a base time offset BTO and a random time offset RTO since a base time offset (BTO=5) set on devices of a second group is greater than a random time offset's maximum value (RTO=3) generated by devices of a first group.

Referring to FIG. 6, before transmission of an RACH preamble from devices of a first group is complete, devices of a second group may transmit a RACH preamble. In this case, at least one of the devices of the first group or the devices of the second group may fail to transmit a RACH preamble. In FIG. 6, a base time offset (BTO=2) set on the devices of the second group is smaller than a maximum value (RTO=3) of a random time offset generated by the devices of the first group. Accordingly, RACH preambles transmitted by both devices of the first group and devices of the second group at a time between 2 seconds and 3 seconds from the reference point may collide, and as a result, transmission of those RACH preambles may fail.

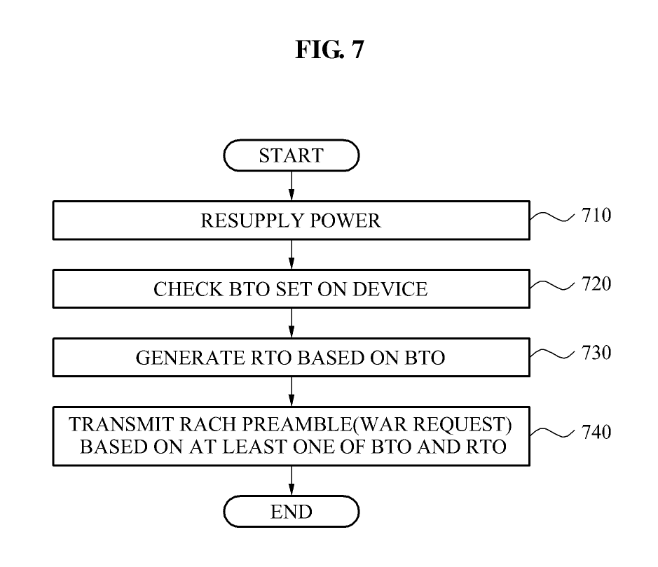

FIG. 7 is a flowchart illustrating a method for transmitting a RACH preamble in a device according to an exemplary embodiment of the present invention.

Operations of the method described with reference to FIG. 7 may be performed internally to or externally from the device 100 shown in FIG. 1.

In operation 710, if devices in a M2M environment are abnormally terminated, power may be resupplied. Power may be supplied to multiple devices at the same time or with a small stagger.

In operation 720, a device resupplied with power may check a base time offset BTO set on and recorded in the device. The base time offset BTO may be recorded in a memory or a universal subscriber identity module (USIM) of the device, or may be recorded externally from the device.

In operation 730, a random time offset RTO used to transmit a RACH preamble (WAR REQUEST) may be allocated to the device at random, based on the checked base time offset BTO. The random time offset RTO may have a value greater than or equal to the base time offset BTO set on the device. The device may generate a random time offset RTO and may allocate the random time offset RTO to the device. Alternatively, if a master device is among the plurality of devices, the master device may generate a random time offset RTO to allocate to the device.

In operation 740, the device may transmit the RACH preamble based on at least one of the base time offset BTO checked in operation 720 and the random time offset RTO allocated in operation 730. For example, the device may transmit an RACH preamble once a period of time corresponding to the random time offset RTO allocated from a reset reference point passes.

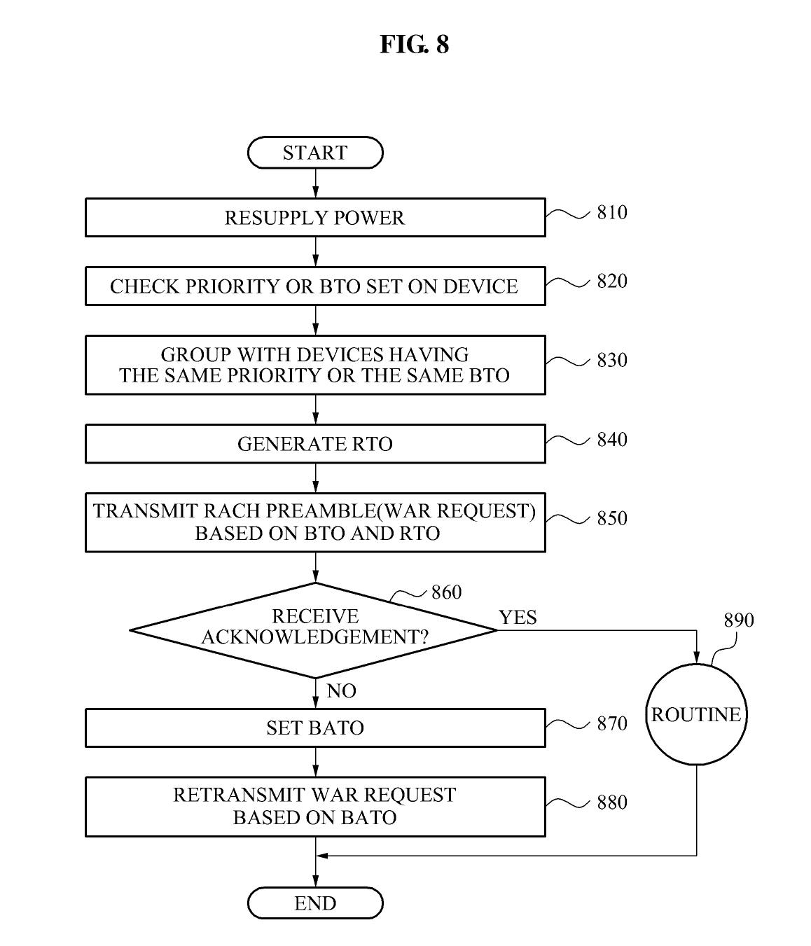

FIG. 8 is a flowchart illustrating a method for transmitting a RACH preamble in a device according to an exemplary embodiment of the present invention.

Each operation of the method of FIG. 8 may be performed internally to or externally from the device 100 shown in FIG. 1.

In operation 810, if devices in a M2M environment are abnormally terminated, power may be resupplied.

In operation 820, the device may check at least one of priority and a base time offset BTO set on and recorded in the device.

In operation 830, the device and other devices having the same priority or the same base time offset BTO as that of the device may be logically grouped into one group.

In operation 840, the device grouped into one group in operation 830 may generate a random time offset RTO based on the base time offset BTO.

In operation 850, the device may transmit a RACH preamble (WAR REQUEST) to a management server based on at least one of the base time offset BTO and the random time offset RTO. If the device is not grouped in operation 830, other devices having the same priority or the same base time offset BTO among the plurality of devices may not exist. In this case, the device may transmit a RACH preamble based on the base time offset BTO, in operation 850. Also in this case, the device may not generate the random time offset RTO in operation 840, if the device is not grouped with another device.

In operation 860, the device may determine whether the device received acknowledgement from the management server. Here, acknowledgement is a signal indicating that access is achieved by successful transmission of the RACH preamble (WAR REQUEST).

In operation 870, if the device does not receive acknowledgement of successful RACH preamble transmission within a predetermined time, a transmission failure may be determined to have occurred and the device may generate a back time offset BATO at random. The back time offset BATO may be generated to reduce the risk of congestion caused by collision of RACH preambles between devices that failed the transmission.

In operation 880, the device that failed the transmission may retransmit the RACH preamble (WAR REQUEST) based on the back time offset BATO generated at random.

In operation 890, if the device receives the acknowledgement of successful RACH preamble transmission in operation 860, the device may perform a corresponding routine.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments, devices in a machine to machine (M2M) environment may transmit a random access control channel (RACH) preamble using a base time offset or a random time offset when the devices are restored to a normal state after abnormal termination. Accordingly, RACH congestion that may occur on initial RACH preamble transmission, and interference between the devices, may be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for transmitting a radio access control channel (RACH) preamble, comprising:
supplying power to a device;
checking a base time offset for the device;
generating a random time offset used to transmit the RACH preamble; and
transmitting the RACH preamble based on at least one of the checked base time offset and the generated random time offset.

2. The method of claim 1, further comprising:
grouping the device into a first group with other devices having a same base time offset as the checked base time offset, the other devices from among a plurality of external devices.

3. The method of claim 1, wherein the generated random time offset is greater than or equal to the checked base time offset.

4. The method of claim 1, wherein the base time offset is set according to an importance of the device.

5. The method of claim 1, further comprising:
setting the base time offset on the device by a master device among a plurality of external devices.

6. The method of claim 1, further comprising:
setting a back time offset if transmission of the RACH preamble fails; and
retransmitting the RACH preamble based on the back time offset.

7. A method for transmitting a radio access control channel (RACH) preamble, comprising:
supplying power to a device;
checking a priority and a base time offset for the device;
grouping the device into a first group with other devices having a same priority as the priority for the device, the other devices from among a plurality of external devices;
generating a random time offset used to transmit the RACH preamble; and
transmitting the RACH preamble based on the random time offset.

8. The method of claim 7, further comprising:
transmitting the RACH preamble based on the checked base time offset if there is no other device having the same priority as the priority for the device among the plurality of external devices.

9. The method of claim 7, wherein generating the random time offset comprises allocating a random time offset based on the base time offset, the base time offset being set according to the priority for the device.

10. The method of claim 9, wherein the random time offset is greater than or equal to the base time offset.

11. The method of claim 7, further comprising:
setting the priority on the device by a master device from among the plurality of external devices.

12. The method of claim 7, wherein the priority is set based on an importance of the device.

13. The method of claim 7, further comprising:
setting a back time offset if transmission of the RACH preamble fails; and
retransmitting the RACH preamble based on the back time offset.

14. A device to transmit a radio access control channel (RACH) preamble, comprising:
a power supply unit;
a control unit to check a base time offset for the device;
an offset generating unit to generate a random time offset used to transmit the RACH preamble; and
a communication unit to transmit the RACH preamble based on at least one of the checked base time offset and the generated random time offset.

15. The device of claim 14, wherein the control unit groups the device into a first group with other devices having a same base time offset as the checked base time offset, the other devices from among a plurality of external devices, and the offset generating unit generates the random time offset on a same condition with the other devices having the same base time offset.

16. The device of claim 15, wherein the same condition corresponds to the random time offset being greater than or equal to the base time offset.

17. The device of claim 14, wherein the base time offset is set according to an importance of a plurality of external devices.

18. The device of claim 14, wherein the offset generating unit sets a back time offset if transmission of the RACH preamble fails, and the communication unit retransmits the RACH preamble based on the back time offset.

19. A device to transmit a radio access control channel (RACH) preamble, comprising:
a power supply unit;
a control unit to check a priority for the device, and to group the device into a first group with other devices having a same priority as the checked priority, the other devices from among a plurality of external devices;
an offset generating unit to generate a random time offset used to transmit the RACH preamble; and
a communication unit to transmit the RACH preamble based on the generated random time offset.

20. The device of claim 19, wherein the offset generating unit sets a back time offset if transmission of the RACH preamble fails, and the communication unit retransmits the RACH preamble based on the back time offset.
